(19) United States
(12) Patent Application Publication
(10) Pub. No.: US 2026/0265509 A1
(43) Pub. Date: Sep. 10, 2026

(54) SILICONE BASED POLYMER PROCESSING AID COMPOSITION

(71) Applicant: Momentive Performance Materials Inc., Niskayuna, NY (US)

(72) Inventors: Shailja Goyal, Bangalore (IN); Sebastian Russell, Bronxville, NY (US); Neal Patel, New York, NY (US); Cheng Diao, White Plains, NY (US); Monjit Phukan, West Harrison, NY (US)

(21) Appl. No.: 19/326,852

(22) Filed: Sep. 12, 2025

(30) Foreign Application Priority Data
Sep. 14, 2024 (IN) 202411069684

(51) Int. Cl. C08L 23/08; B29C 48/00; B29C 48/36; B29K 23/00; B29K 67/00; B29K 71/00; B29K 83/00; C08K 5/098

(52) U.S. Cl. CPC C08L 23/08; B29C 48/022; B29C 48/36; C08K 5/098; B29K 2023/0625; B29K 2067/046; B29K 2071/02; B29K 2083/00; C08L 2205/03; C08L 2205/06; C08L 2310/00

(57) ABSTRACT

A polymer processing aid is shown and described herein. The polymer processing aid comprises a silicone-based polymer and an adjuvant. The polymer processing aid can be employed in a polymer composition that is extruded to form a polymer material. The polymer processing aid can improve material processability, reduce process pressure, and promote other desirable effects that include, for example, reducing melt fracture and the negative effects thereof in a polymer product.

### CROSS-REFERENCE TO RELATED APPLICATIONS

This application claims priority to and the benefit of India Provisional Application No. 202411069684, titled “SILICONE BASED POLYMER PROCESSING AID COMPOSITION,” filed on Sep. 14, 2024, the disclosure of which is incorporated herein by reference in its entirety.

### FIELD OF INVENTION

The present technology relates to a polymer processing aid composition suitable for use in processing thermoplastic polymers. In particular, the present technology relates to a polymer processing aid comprising a silicone polymer and an adjuvant. The present technology also relates to processing of thermoplastic polymers with such polymer processing aid compositions and thermoplastic materials formed therefrom.

### BACKGROUND

Thermoplastic polymers are melt processed above their melting temperature prior to being fabricated into a desired form such as, for example, a tube, sheet, film, and the like. Thermoplastic polymers can be melt processed using a variety of techniques such as, for example, blown film processing, cast film processing, sheet extrusion, profile extrusion, blow molding, fiber spinning, and the like. The shear stresses that occur during melt processing techniques and the high rates of throughput cause flow instabilities in the melt which results in surface defects in the final product. These defects are commonly referred to as melt fracture. When the shear rate exceeds the critical shear rate, the polymer may exhibit surface melt fracture caused by the successive sticking and slipping of the polymer melt on the metal die surface used to process the polymer. This surface melt fracture may also refer to as shark skinning and is seen as a rough or jagged surface on the extrudate. Melt fracture/surface melt fracture can introduce haze into the final product, which negatively affects the optical clarity of the product and may give the product a dull or hazy appearance. For many products such as, for example, plastic storage bags, food wraps, etc., this dull or hazy appearance is undesirable.

Polymer processing aids are often added during melt processing to eliminate melt fracture and improve processing efficiency. Silicone-based materials are one solution available in the market as a processing aid to overcome the issues associated with melt fracture during melt processing. These materials are generally incompatible with the polymer melt and migrate towards the die metal surface of the processing system. They build a coating on the die metal surface, which creates a “slippery” surface at the interface of the die metal surface and the polymer melt. The polymer melt “slips” through the die such that there is less instability as the polymer melt passes that would lead to melt fracture. Silicone polymers also reduce the melt pressure in the system, which allows for higher production throughputs.

Desirably, the processing aid is fast acting in terms of the time to eliminate melt fracture. The processing aid may generally be added at the same time as the polymer being processed, and the efficiency would be evaluated in terms of the minimum time to eliminate melt fracture. This may also be evaluated by the reduction in pressure that occurs at the end/exit point of the metal die.

Various additives may be added to a polymer melt to impart certain properties or characteristics to the final polymer product. Some additives may interfere with the performance of the polymer processing aid. For example, some polar molecules may be surface active and reduce the efficacy of the silicone-based polymer processing aids on the die metal surface. There is a need for a processing aid composition that addresses the above mentioned disadvantages.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

In one aspect, provided is a polymer processing aid comprising (i) a silicone polymer, and (ii) an adjuvant. In one embodiment, the silicone polymer is halogen free.

In one embodiment, the adjuvant is selected from (i) an aliphatic polyester, and/or an aromatic polyester; (ii) a polyether; (iii) a polyglycerol, and/or a polyglycerol fatty acid ester; (iv) a polyacrylic acid or a derivative thereof; (v) an ethylene-maleic anhydride copolymer; (vi) a polyvinyl alcohol or a derivative thereof; (vii) a cellulose derivative; and/or (vii) polymers or blends of derivatives of polystyrene, poly(meth)acrylate, polyamides, polycarbonates, polysulfones, etc.

In one embodiment, the adjuvant is selected from a polyethylene glycol having a weight average molecular weight of from about 200 to about 200,000. In one embodiment, the polyethylene glycol has a weight average molecular weight above 20,000.

In one aspect, provided is a masterbatch composition comprising (i) the silicone polymer, (ii) an adjuvant, and (iii) a carrier material comprising a thermoplastic polymer.

In another aspect, provided is a composition for preparing a thermoplastic material comprising (a) a thermoplastic polymer; and (b) a polymer processing aid comprising (i) a silicone polymer, and (ii) an adjuvant.

In one embodiment, the composition comprises a product additive selected from antioxidants (such as phenols, amines, phosphites, thioesters), UV Stabilizers (e.g., UV absorbers and quenchers, hindered amine light stabilizers), oxygen scavengers, plasticizers, viscosity modifiers, nucleating agents, compatibilizers, clarifying agents, antistatic agents, fillers, pigments, acid neutralizers (e.g., glycerol monostearate, zinc oxide, zinc stearate, calcium stearate, and the like), antiblocking agents (diatomaceous earth, natural/synthetic silica, talc, CaCO3, ceramic spheres, and the like) etc.

In still another aspect, provided is a method of forming a polymer material comprising subjecting a thermoplastic polymer to a melt processing operation in the presence of a polymer processing aid comprising a silicone polymer and an adjuvant.

In one aspect, provided is a polymer processing aid comprising:
(i) a silicone polymer of the formula:

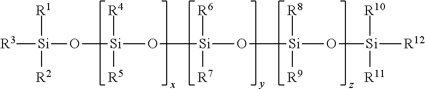

where R¹, R², R⁴, R⁵, R⁶, R⁸, R¹⁰, and R¹¹ are independently selected from a C1-C12 alkyl;
   R⁷ is selected from an organic group selected from an alkylene oxide group, a hydroxy group, an alcohol, a carboxy group, an alkoxy group, an epoxy group, or an amino group;
R³, R⁹, and R¹² are independently selected from a C1-C12 alkyl and R⁷;
x is 1 to 500;
y is 1 to 300; and
z is 0 to 500;
(ii) an adjuvant selected from an aliphatic polyester; an aromatic polyester; a polyether; a polyglycerol, and/or a polyglycerol fatty acid ester; a polyacrylic acid or a derivative thereof; an ethylene-maleic anhydride copolymer; a polyvinyl alcohol or a derivative thereof; a cellulose derivative; a polymer of polystyrene, poly(meth)acrylate, polyamides, polycarbonates, polysulfones; or a combinations thereof; polylactic acid; and
(iii) a product additive selected from a pigment, a dye, a heat stabilizer, a UV stabilizer, an antiblock agent, an acid neutralizer, or a combination of two or more thereof.

In one embodiment, the product additive is selected from an acid neutralizer, where the acid neutralizer is selected from an alkaline earth oxide, alkaline earth carbonate, a hydrotalcite-like compound, a metal carboxylate or a combination of two or more thereof.

In one embodiment, the acid neutralizer is selected from zinc oxide, zinc stearate, calcium stearate, or a combination of two or more thereof.

In one embodiment in accordance with any previous aspect or embodiment, the adjuvant is selected from a polyether, an aliphatic polyester, an aromatic polyester, or a combination of two or more thereof.

In one embodiment in accordance with any previous aspect or embodiment, the adjuvant comprises a polyether selected from a polyether glycol.

In one embodiment in accordance with any previous aspect or embodiment, the adjuvant comprises polyethylene glycol, polycaprolactone, or a combination of two or more thereof.

In one embodiment, the adjuvant has a weight average molecular weight of from about 200 to about 200,000 g/mol.

In one embodiment, the adjuvant has a weight average molecular weight of from greater than 20,000 to about 200,000 g/mol.

In one embodiment in accordance with any previous aspect or embodiment, the polymer processing aid has a ratio of silicone polymer (i) to adjuvant (ii) of from about 4:1 to about 1:4 on a weight basis.

In one embodiment in accordance with any previous aspect or embodiment, the polymer processing aid has a ratio of silicone polymer (i) to adjuvant (ii) of 1:1 on a weight basis.

In one embodiment in accordance with any previous aspect or embodiment, the silicone polymer (i) has a weight average molecular weight of from about 500 to about 1,000,000 g/mol.

In one embodiment in accordance with any previous aspect or embodiment, the product additive is selected from a metal carboxylate, hydrotalcite-like compounds, hydrocalumites, zeolites, alkaline earth oxides, alkaline earth carbonates, glycerin fatty acid esters.

In one embodiment in accordance with any previous aspect or embodiment, the product additive is selected from an antiblock material selected from natural silica; synthetic silica; a silicate; a synthetic zeolite; a polymethylsilsesquioxane; talc; calcium carbonate; mica; or a combination thereof.

In one embodiment in accordance with any previous aspect or embodiment, the polymer processing aid is in the form of a masterbatch, wherein the silicone polymer (i), the adjuvant (ii), and the product additive (iii) are disposed in a carrier resin.

In one embodiment, the carrier resin is selected from a thermoplastic polymer.

In one embodiment, the thermoplastic polymer is selected from a polyolefin.

In another aspect, provided is an extrudable composition comprising (i) a thermoplastic polymer, and (ii) the polymer processing aid of any of the previous aspects or embodiments.

In one embodiment, the polymer processing aid is present in an amount of from about 100 ppm to about 10,000 ppm based on the total weight of the composition.

In one embodiment in accordance with any previous aspect or embodiment, the thermoplastic polymer is selected from a polyolefin, a polyamide, a polyester, a styrenic polymer, an acrylic, a methacrylic, polyoxyalkylene, a diene elastomer, a polyacetal, a polycarbonate, a polysulfone, a polyurethane, or a combination of two or more thereof.

In one embodiment in accordance with any previous aspect or embodiment, the thermoplastic polymer is selected from a polyolefin.

In one embodiment, the polyolefin is selected from a polyethylene polymer.

In one embodiment in accordance with any previous aspect or embodiment, the extrudable composition further comprises a product additive selected from an antioxidants, a nucleating agent, an acid scavenger, a stabilizer, an anticorrosion agent, a plasticizer, a blowing agent, a cavitating agent, a surfactant, a block, an antiblock, a UV absorber, a quenchers, an antistatic agent, a slip agent, a processing aid, a UV stabilizer, a neutralizer, a lubricant, a wax, a pigment, a dye, a filler, a cure agent, or combination of two or more thereof.

In one embodiment, the product additive is present in an amount of from about 0.001 wt. % to about 30 wt. % based on the weight of the composition.

In one embodiment in accordance with any previous aspect or embodiment, the product additive is selected from a metal carboxylate.

In one embodiment, the metal carboxylate is selected from zinc stearate.

In one embodiment in accordance with any previous aspect or embodiment, the product additive is present in an amount of from about 0.001 wt. % to about 1 wt. % based on the weight of the composition.

In one embodiment in accordance with any previous aspect or embodiment, the adjuvant has a weight average molecular weight of from greater than 20,000 to about 200,000 g/mol.

In still another aspect, provided is a process of forming a polymeric material comprising extruding the composition of any of the previous aspects or embodiments through an extruder die.

In yet another aspect, provided is an extruded thermoplastic product produced from the extrudable composition of any of the previous aspects or embodiments.

In a further aspect, provided is a polymer processing aid comprising:
(i) a silicone polymer of the formula:

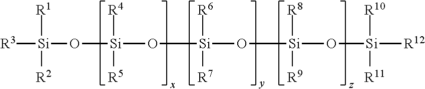

where R¹, R², R⁴, R⁵, R⁶, R⁸, R¹⁰, and R¹¹ are independently selected from a C1-C12 alkyl;
R⁷ is selected from an organic group selected from an alkylene oxide group, a hydroxy group, an alcohol, a carboxy group, an alkoxy group, an epoxy group, or an amino group;
R³, R⁹, and R¹² are independently selected from a C1-C12 alkyl and R⁷;
x is 1 to 500;
y is 1 to 300; and
z is 0 to 500;
(ii) an adjuvant selected from an aliphatic polyester; an aromatic polyester; a polyether; or a combinations thereof, wherein the adjuvant has a weight average molecular weight of greater than 20,000 g/mol.

In one embodiment, the adjuvant has a weight average molecular weight of from greater than 20,000 to about 200,000 g/mol.

In one embodiment in accordance with any previous aspect or embodiment, a ratio of silicone polymer (i) to adjuvant (ii) of from about 9:1 to about 1:9 on a weight basis.

In another aspect, provided is an extrudable composition comprising (i) a thermoplastic polymer, and (ii) the polymer processing aid of any of the previous aspect or embodiments.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 is a graph showing the pressure drop versus time in an extrudate for various examples discussed herein.

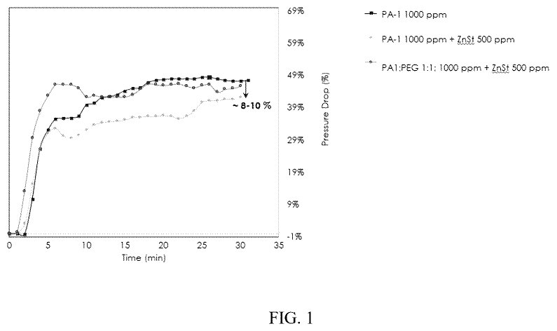

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It will be appreciated that ranges for a particular component can be combined to form new and non-specified ranges.

As used herein, unless indicate otherwise, “molecular weight” refers to weight average molecular weight. The weight average molecular weight indicates a polydimethylsiloxane-equivalent weight average molecular weight measured by gel permeation chromatography with an evaporative light scattering detector (GPC-ELSD) in dichloromethane.

Provided is a polymer processing aid comprising a silicone-based polymer and an adjuvant. The polymer processing aid may be used in melt processing of thermoplastic polymers and functions to reduce melt fracture in melt processing of a thermoplastic polymer. Further, the polymer processing aid is particularly suitable for use with thermoplastic polymer compositions that include product additives such as, for example, acid neutralizers. The present processing aid can be employed at generally low levels and still provide effective reduction of melt fracture. The polymer processing aid comprises (i) a silicone-based polymer, (ii) an adjuvant, and (iii) optionally a product additive selected from pigments and dyes, heat stabilizers, light and UV stabilizers, antiblock agents, acid neutralizers.

The combination of the silicone-based polymer, the adjuvant, and optionally the product additive provide a polymer processing aid that provide faster melt fracture elimination and increased processibility conditions. This may include, for example, lower pressures during melt processing and higher throughputs.

The silicone-based polymer is selected from a polysiloxane polymer comprising organic functional groups. The silicone-based polymer may be linear (comprising M and D units) or branched (comprising M, D, and T and/or Q units). The designation of M, D, T, and Q units is nomenclature commonly used with silicone polymer and understood by those skilled in the art.

In one embodiment, the silicone-based polymer is selected from a compound of the formula:

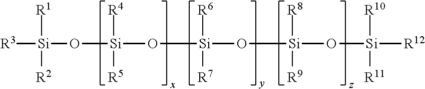

where R¹, R², R⁴, R⁵, R⁶, R⁸, R¹⁰, and R¹¹ are independently selected from a C1-C12 alkyl;
R⁷ is selected from an organic group selected from an alkylene oxide group, a hydroxy group, an alcohol, a carboxy group, an alkoxy group, an epoxy group, or an amino group;
R³, R⁹, and R¹² are independently selected from a C1-C12 alkyl and R⁷;
x is 1 to 500;
y is 1 to 300; and
z is 0 to 500.

R¹, R², R⁴, R⁵, R⁶, R⁸, R¹⁰, and R¹¹, and optionally R³, R⁹, and R¹² are independently selected from a C1-C12 alkyl, a C2-C10 alkyl, a C3-C8 alkyl, or a C4-C6 alkyl. In embodiments, R¹, R², R⁴, R⁵, R⁶, R⁸, R¹⁰, and R¹¹, and optionally R³, R⁹, and R¹² are selected from a C1-C4 alkyl.

In one embodiment, R¹, R², R⁴, R⁵, R⁶, R⁸, R¹⁰, and R¹¹, and optionally R³, R⁹, and R¹² are each selected from methyl.

R⁷ is selected from an organic group selected from an alkylene oxide group, a hydroxy group group, an alkoxy group, an epoxy group, or an amino group. In one embodiment, R⁷ is selected from an alkylene oxide group of the formula:

—R¹³—(OC₂H₄)ₘ—(OC₃H₆)ₙ—OR¹⁴

where R¹³ is a divalent C2-C6 group; R¹⁴ is selected from H or a C1-C12 alkyl; n is 0 to 200; and m is 0 to 200. In embodiments, R¹³ is a divalent C3 group, and R¹⁴ is H or —CH₃. In one embodiment, m is 0 and n is 1 to 200, 5 to 175, 10 to 150, 20 to 125, 25 to 100, 30 to 90, 40 to 80, or 50 to 75. In one embodiment, n is 0 and m is 1 to 200, 5 to 175, 10 to 150, 20 to 125, 25 to 100, 30 to 90, 40 to 80, or 50 to 75. In one embodiment, n is 1 to 200, 5 to 175, 10 to 150, 20 to 125, 25 to 100, 30 to 90, 40 to 80, or 50 to 75; and m is 1 to 200, 5 to 175, 10 to 150, 20 to 125, 25 to 100, 30 to 90, 40 to 80, or 50 to 75.

In one embodiment, R⁷ is selected from a hydroxyl functional group of the formula —R¹⁵—OH, where R¹⁵ is a C1 to C10 divalent alkyl group.

In one embodiment, the R⁷ is selected from a carboxy functional group of the formula:

—R¹⁶—C(O)—OR¹⁷

where R¹⁶ is a C1-C12 divalent alkyl group; and R¹⁷ is selected from H or a C1-C12 alkyl group. In one embodiment, R¹⁷ is selected from a C1-C12, C2-C10, C3-C8, or C4-C6 alkyl group.

In one embodiment, R⁷ is selected from an alkoxy group of the formula —OR¹⁸, were R¹⁸ is selected from a C1-C12 alkyl, a C2-C10 alkyl, a C3-C8 alkyl, or a C4-C6 alkyl. In one embodiment, R¹⁸ is —CH3.

In one embodiment, R⁷ is selected from an epoxy group of the formula:

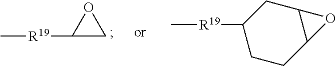

where R¹⁹ is a C1-C12 divalent alkyl group.

In one embodiment, R⁷ is selected from an amino group of the formula:

—R²⁰—N(R²¹)(R²²); or

—R²³—NH—R²⁴—N(R²⁵)(R²⁶)

where R²⁰, R²³, and R²⁴ are independently selected from a C1-C12 divalent alkyl group; and R²¹R²², R²⁵, and R²⁶ are independently selected from H or a C1-C12 alkyl. In embodiments, R²⁰, R²³ and R²⁴ are independently selected from a C1-C12, a C2-C10, a C3-C8, or a C4-C6 divalent alkyl group. In embodiments, R²¹, R²², R²⁵, and R²⁶ are independently selected from a C1-C12, a C2-C10, a C3-C8, or a C4-C6 alkyl group.

In embodiments of the silicone-based polymer:
x is 1 to 500, 2 to 475, 5 to 450, 10 to 425, 15 to 400, 20 to 374, 25 to 350, 30 to 325, 40 to 300, 50 to 275, 75 to 250, 85 to 225, 90 to 200, 100 to 175, or 125 to 150;
y is from 1 to 300, 2 to 275, 5 to 250, 10 to 225, 20 to 200, 25 to 175, 30 to 150, 40 to 125, 50 to 100, or 60 to 75; and
x is 0.

In embodiments of the silicone-based polymer:
x is 100 to 300, 110 to 275, 125 to 250, or 150 to 200;
y is from 1 to 50, 2 to 45, 5 to 40, 10 to 30, or 15 to 25; and
x is 0.

In embodiments of the silicone-based polymer:
x is 1 to 500, 2 to 475, 5 to 450, 10 to 425, 15 to 400, 20 to 374, 25 to 350, 30 to 325, 40 to 300, 50 to 275, 75 to 250, 85 to 225, 90 to 200, 100 to 175, or 125 to 150;
y is from 1 to 300, 2 to 275, 5 to 250, 10 to 225, 20 to 200, 25 to 175, 30 to 150, 40 to 125, 50 to 100, or 60 to 75; and
x is 1 to 500, 2 to 475, 5 to 450, 10 to 425, 15 to 400, 20 to 374, 25 to 350, 30 to 325, 40 to 300, 50 to 275, 75 to 250, 85 to 225, 90 to 200, 100 to 175, or 125 to 150.

In an exemplary embodiment, the silicone-based processing aid comprises an amine functional group in the pendant position, as shown in Structure A:

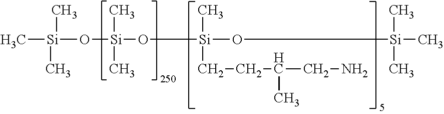

In an exemplary embodiment, the silicone processing aid comprises epoxy functional groups as shown in Structure B:

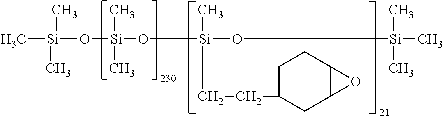

In embodiments, the silicone-based polymer has a weight average molecular weight of from about 500 to about 1,000,000 g/mol, from about 1,000 to about 750,000 g/mol, from about 2,500 to about 500,000 g/mol, from about 5,000 to about 250,000 g/mol, from about 7,500 to about 200,000 g/mol, from about 10,000 to about 150,000 g/mol, from about 12,000 to about 150,000 g/mol, from about 15,000 to about 125,000 g/mol, from about 20,000 to about 100,000 g/mol, from about 25,000 to about 75,000 g/mol, or from about 30,000 to about 50,000 g/mol.

The polymer processing aid includes an adjuvant. The combination of the adjuvant with the silicone-based polymer has been found to provide a polymer processing aid with improved performance in terms of reducing melt fracture elimination and/or reduction in pressure at the die outlet. This benefit may also be seen when used in processing of thermoplastics that employ certain product additives.

In one embodiment, the adjuvant is selected from (i) an aliphatic polyester, and/or an aromatic polyester; (ii) a polyether; (iii) a polyglycerol, and/or a polyglycerol fatty acid ester; (iv) a polyacrylic acid or a derivative thereof; (v) an ethylene-maleic anhydride copolymer; (vi) a polyvinyl alcohol or a derivative thereof; (vii) a cellulose derivative; (vii) polymers or blends of derivatives of polystyrene, poly(meth)acrylate, polyamides, polycarbonates, polysulfones, etc.; or a combination of two or more thereof.

In one embodiment, the adjuvant has a weight average molecular weight of from about 200 to about 200,000 g/mol, from about 500 to about 150,000 g/mol, from about 750 to about 125,000 g/mol, from about 1,000 to about 100,000 g/mol, from about 2,500 to about 75,000 g/mol, from about 5,000 to about 50,000 g/mol, or from about 7,500 to about 20,000 g/mol. In one embodiment, the adjuvant has a molecular weight of from about 20,000 g/mol to about 200,000 g/mol, from about 25,000 g/mol to about 190,000 g/mol, from about 30,000 g/mol to about 180,000 g/mol, from about 40,000 g/mol to about 175,000 g/mol, from about 45,000 g/mol to about 160,000 g/mol, from about 50,000 g/mol to about 150,000 g/mol, from about 60,000 g/mol to about 125,000 g/mol, or from about 75,000 g/mol to about 100,000 g/mol.

In one embodiment, the adjuvant is selected from an aliphatic polyester, an aromatic polyester, or a mixture thereof. Examples of such polyesters include, but are not limited to, polylactic acid, poly(glycolide) s, poly(lactide-co-glycolide), poly(butyrolactone), poly(hydroxyalkanoate), poly(valerolactone), polcaprolactone, and the like.

In one embodiment, the adjuvant is selected from a polyether. Examples of polyethers include, but are not limited to, polyethylene glycol, polypropylene glycol, and the like. In one embodiment, the polyether may be functionalized. In one embodiment, the polyether is functionalized with a fatty acid. Such functionalized polyethers may be the condensation products of alkylene oxides with both fatty acids and fatty alcohols (i.e, wherein the polyalkylene oxide portion is esterified on one end with a fatty acid and etherified (i.e. connected via an ether linkage) on the other end with a fatty alcohol). These materials have the general formula R²⁷CO(X)ₙOR²⁸ wherein R²⁷ and R²⁸ are C10-30 alkyl groups, X is —OCH₂CH₂ (i.e., derived from ethylene glycol or oxide) or —OCH₂CHCH₃-(derived from propylene glycol or oxide), and n is an integer from about 6 to about 100. Examples of these alkylene oxide derived materials include, but are not limited to, ceteth-6, ceteth-10, ceteth-12, ceteareth-6, ceteareth-10, ceteareth-12, steareth-6, steareth-10, steareth-12, PEG-6 stearate, PEG-10 stearate, PEG-100 stearate, PEG-12 stearate, PEG-20 glyceryl stearate, PEG-80 glyceryl tallowate, PEG-10 glyceryl stearate, PEG-30 glyceryl cocoate, PEG-80 glyceryl cocoate, PEG-200 glyceryl tallowate, PEG-8 dilaurate, PEG- 10 distearate, and mixtures of two or more thereof. In one embodiment, the polyether may be selected from a polyethylene glycol distearate.

In one embodiment, the adjuvant is selected from polyether or polyester having a weight average molecular weight of from about 200 to about 200,000 g/mol, from about 500 to about 150,000 g/mol, from about 750 to about 125,000 g/mol, from about 1,000 to about 100,000 g/mol, from about 2,500 to about 75,000 g/mol, from about 5,000 to about 50,000 g/mol, or from about 7,500 to about 20,000 g/mol.

In one embodiment, the polyether or polyester has a weight average molecular weight of greater than 20,000 g/mol. In embodiments, the polyether or polyester has a weight average molecular weight of from about 20,000 to about 200,000 g/mol, from about 22,000 to about 175,000 g/mol, from about 25,000 to about 150,000 g/mol, from about 30,000 to about 125,000 g/mol, or from about 35,000 to about 100,000 g/mol, from about 40,000 to about 75,000 g/mol, or from about 50,000 to about 60,000 g/mol.

In one embodiment, the adjuvant is selected from a polyglycerol, a polyglycerol fatty acid ester, or mixtures thereof. Examples of suitable polyglycerols include, but are not limited to, polyglycerol polyricinoleic acid, acrylic grafted polyols, and the like.

In one embodiment, the adjuvant is selected from a polyacrylic acid and derivatives therefore. Examples of polyacrylic acids include, but are not limited to, ethylene-acrylic copolymers and other acrylate based copolymers.

In one embodiment, the adjuvant is selected from ethylene-maleic anhydride copolymers.

In one embodiment, the adjuvant is selected from polyvinyl alcohol and derivatives thereof.

In one embodiment, the adjuvant is selected from cellulose derivatives.

In one embodiment, the adjuvant is selected from polymers or blends of derivatives of polystyrene, poly(meth)acrylate, polyamides, polycarbonates, polysulfones, etc.

The polymer processing aid may be provided as a liquid composition or as a masterbatch. Generally, the polymer processing aid comprises the silicone-based polymer and adjuvant in a ratio of silicone-based polymer to adjuvant of from about 1:9 to about 9:1; from about 1:7 to about 7:1; from about 1:5 to about 5:1, from about 1:2.5 to about 2.5:1, from about 1:2 to about 2:1, or from about 1:1.5 to about 1.5:1 on a weight basis. In one embodiment, the polymer processing aid comprises the silicone-based polymer and adjuvant in a weight ratio of silicone-based polymer to adjuvant of about 1:1.

In one embodiment, the polymer processing aid comprises an adjuvant selected from a polyether, a polyester, or a combination thereof, and the ratio of the silicone-based polymer to the adjuvant is from about 1:4 to about 4:1, from about 1:2 to about 2:1, or from about 1:1.5 to about 1.5:1. In one embodiment, the ratio is 1:1.

The polymer processing aid can include (iii) a product additive selected from pigments and dyes, heat stabilizers, light and UV stabilizers, antiblock agents, acid neutralizers. These materials are described in greater detail herein.

In one embodiment, the polymer processing aid comprises (i) the silicone-based polymer, (ii) the adjuvant, and (iii) the product additive selected from pigments and dyes, heat stabilizers, light and UV stabilizers, antiblock agents, acid neutralizers, or combinations thereof.

In one embodiment, the polymer processing aid comprises (i) the silicone-based polymers, and (ii) the adjuvant selected from a polyether, a polyester, or a combination thereof, wherein the adjuvant has a weight average molecular weight greater than 20,000 g/mol. In one embodiment, the adjuvant is a polyether, polyester, or a combination thereof, wherein the adjuvant has a weight average molecular weight of from greater than 20,000 to about 200,000 g/mol, from about 500 to about 150,000 g/mol, from about 750 to about 125,000 g/mol, from about 1,000 to about 100,000 g/mol, from about 2,500 to about 75,000 g/mol, from about 5,000 to about 50,000 g/mol. In one embodiment, the polymer processing aid comprising the adjuvant with a weight average molecular weight greater than 20,000 g/mol.

In some embodiments, the polymer processing aid comprises the silicone-based polymer and adjuvant in a weight ratio of the silicone-based polymer to the adjuvant of from about 1:9 to about 9:1; from about 1:7 to about 7:1; from about 1:5 to about 5:1, from about 1:2.5 to about 2.5:1, from about 1:2 to about 2:1, or from about 1:1.5 to about 1.5:1 on a weight basis. In one embodiment, the polymer processing aid comprises the silicone-based polymer and adjuvant in a weight ratio of silicone-based polymer to adjuvant of about 1:1.

In one embodiment, the polymer processing aid with this larger molecular weight adjuvant also includes (iii) the product additive.

The product additive may be present in the polymer processing aid composition an amount of from about 0.001 wt. % to about 50 wt. %, from about 0.005 wt. % to about 40 wt. %, from about 0.01 wt. % to about 25 wt. %, from about from about 0.2 wt. % to about 10 wt. % based on the total weight of the polymer processing aid composition. In embodiments, the product additive (iii) is present in an amount of from about 0.001 wt. % to about 1 wt. %, from about 0.005 wt. % to about 0.9 wt. %, from about 0.01 wt. % to about 0.8 wt. %, from about 0.05 wt. % to about 0.75 wt. %, from about 0.075 wt. % to about 0.6 wt. %, or from about 0.1 wt. % to about 0.5 wt. % based on the total weight of the polymer processing aid composition. Materials suitable for the product additive include those described herein with respect to the product additives that may be added to the thermoplastic resin such as, for example, antioxidants, nucleating agents, acid scavengers, stabilizers, anticorrosion agents, plasticizers, blowing agents, cavitating agents, surfactants, adjuvants, block, antiblock, UV absorbers such as chain-breaking antioxidants, etc., quenchers, antistatic agents, slip agents, processing aids, UV stabilizers, neutralizers, lubricants, waxes, color masterbatches, pigments, dyes and fillers and cure agents such as peroxide.

In one embodiment, the polymer processing aid is provided as a masterbatch composition. The masterbatch comprises the silicone-based polymer, the adjuvant, and optionally the product additive disposed in a carrier polymer. The silicone-based polymer, adjuvant, and optionally the product additive are mixed into the carrier polymer at an elevated temperature, and the mixture is then cooled and solidified and then subsequently cut into granules, pellets, or other solid particles. The carrier polymer is not particularly limited. Generally, the carrier polymer is selected such that it is miscible with the polymer system to which the polymer processing aid is to be added. In embodiments, the carrier polymer to form the masterbatch is selected to be the same as the polymer that is being subjected to the melt processing operation. In another embodiment, the adjuvant is selected as the carrier resin or the carrier resin is selected from the same class of material as the adjuvant, and the silicone-based polymer is loaded in that resin to form the masterbatch.

Examples of materials suitable for the carrier resin include, but are not limited to, vinyls, styrenics, acrylics, methacrylics, diene elastomers, thermoplastic elastomers. polyacetals, polyethers, polyesters, polyamides, polycarbonates, polysulfones, polyurethanes, and the like. In one embodiment, the carrier resin is selected from a polyether or polyester.

The polymers to which the present processing aids are added, including the properties, type, and size thereof, can be selected as desired for a particular purpose or intended application. Examples of suitable polymers include, but are not limited to, thermoplastic polymers. Thermoplastic polymers may include crosslinkable or vulcanizable elastomers, as long as they can be fabricated by standard thermoplastic melt processing techniques such as extrusion, milling, calendaring, injection molding, melt spinning into fibers, and the like. One group of polymers is addition polymers. Examples of such polymers include, but are not limited to, polyolefins, vinyls, styrenics, acrylics and methacrylics, diene elastomers, thermoplastic elastomers and polyacetals. Another major group is condensation polymers. Examples of condensation polymers include, but are not limited to, polyesters, polyamides, polycarbonates, polysulfones, and polyurethanes. Still another polymer group is the thermoplastic cellulosic ethers and esters.

Examples of polyolefins include, but are not limited to, homopolymers, copolymers, and terpolymers of ethylene, propylene, butene-1,4-methyl pentene-1, isobutylene and co- and terpolymers thereof, including co- and terpolymers with dienes and with polar monomers.

Examples of vinyl polymers include, but are not limited to, polyvinyl chloride, polyvinyl acetate, polyvinyl alcohol, polyacrylonitrile and the co- and terpolymers thereof, including co- and terpolymers with other monomers such as maleic anhydride and maleic acid.

Examples of styrenic polymers include, but are not limited to, polystyrene, poly α-methyl styrene, the co- and terpolymers thereof and with other monomers such as acrylonitrile, methyl methacrylate, and the like. These may also include rubber modified impact resistant polymer blends.

Examples of acrylic and methacrylic polymers include, but are not limited to, polyacryclic acid and polymethacrylic acid, their copolymers, esters, and salts.

Examples of polydienes include, but are not limited to, polybutadiene, polyisoprene, polychloroprene, polycyanoprene and copolymers thereof, specifically the co and terpolymers with styrene and acrylonitrile.

Examples of polyacetals include, but are not limited to, polymethylene oxide, polytrioxane and copolymers thereof.

Examples of polyesters include, but are not limited to, polyethylene terephthalate, polybutylene terephthalate, polyethylene isophthalate and their copolymers. Examples of polyamids are poly-8-caprolactam, polyhexamethylene adipamide and polyhexamethylene sebacamide. An example of a polycarbonate is the reaction product of a bisphenol A with diphenyl carbonate and an example of a polysulfone is the reaction product of an alkaline salt of bisphenol A with p,p′-dichlorophenyl sulfone.

Examples of polyethers include, but are not limited to, polyoxyalkylene polymers such as polyethylene glycol.

Examples of polyurethanes include, but are not limited to, the fiber-forming polymer made from hexamethylene diisocyanate and tetramethylene glycol and the elastomeric polymer made from diphenylmethane p,p′-diisocyanate, adipic acid and butanediol 1,4.

Examples of thermoplastic cellulosics are ethyl cellulose, cellulose acetate, cellulose butyrate, hydroxy propyl cellulose, and the like.

It will be appreciated that the carrier resin can be a polmyer resin that is a copolymer of two or more different types of polymers. Such polymers can be selected as desired for a particular purpose or intended use. In one embodiment, the carrier resin is selected from a copolymer of polyethylene glycol and polycaprolactone.

In one embodiment, the polymer for forming the material/article of interest is selected from an olefin polymer. The olefin polymer can be a polymer, copolymer, terpolymer, and/or a blend thereof. The polymer may employ one or more olefin monomers such as, but not limited to, ethylene, propylene, butene-1, isobutylene, pentene, hexene 1,4 methyl-pentene, octene, nonene, and decene; interpolymers with dienes such as, but not limited to, ethylidene norbornene, cyclopentadiene, hexadiene; interpolymers with polar monomers such as, but not limited to, vinyl acetate; vinyl alcohol; acrylic acid and methacrylic acid, their esters and salts; acrylamide and methacrylamide and N-alkyl versions thereof; and the like. In embodiments, the olefin polymer is selected from a homopolymer or copolymer blend of one or more of LDPE (low density, high pressure polyethylene), HDPE (high density polyethylene), LLDPE (linear low density polyethylene), PP (isotactic polypropylene), EPR (ethylene/propylene rubber), EPDM (ethylene/propylene/diene monomer), EVA (ethylene/vinyl acetate), EEA (ethylene/ethyl acrylate), and EAA (ethylene/acrylic acid).

In embodiments, the ethylene polymers are low pressure, substantially linear ethylene homopolymers and ethylene-C3 to C8 alpha olefin interpolymers having a density of about 0.850 to about 0.970, preferably about 0.875 to about 0.930. These polymers can be prepared by reacting a mixture containing about 50 to 99.9 mole percent, preferably about 75 to 96 mole percent ethylene and from about 0.1 to 50 mole percent and preferably about 4 to about 25 mole percent of one or more C3 to C8 alpha olefins such as propylene, butene-1, pentene-1,4-methyl-pentene-1, hexene-1, heptene-1, octene-1 and the like, using a magnesium chloride/titanium chloride catalyst and employing low pressures on the order of about 15 to 300 psi.

The thermoplastic polymers are available in various types and grades and may be formulated with other ingredients into powders, pellets, flakes, granules, liquid reins or solutions.

The thermoplastic polymer composition may also contain one or more product additives. Examples of product additives include, for example, antioxidants, nucleating agents, acid scavengers, stabilizers, anticorrosion agents, plasticizers, blowing agents, cavitating agents, surfactants, adjuvants, block, antiblock, UV absorbers such as chain-breaking antioxidants, etc., quenchers, antistatic agents, slip agents, processing aids, UV stabilizers, neutralizers, lubricants, waxes, color masterbatches, pigments, dyes and fillers and cure agents such as peroxide. In embodiments, the product additives, if present, may each individually present at about 0.001 wt. % to about 50 wt. %, in one embodiment, from about 0.01 wt. % to about 10 wt. %, in another embodiment, from about 0.1 wt. % to about 6 wt. %, and in another embodiment, based upon the total weight of the thermoplastic polymer composition. In embodiments, dyes and other colorants common in the industry may be present from about 0.01 wt. % to about 10 wt. % in one embodiment, and from about 0.1 wt. % to about 6 wt. % in another embodiment, based upon the total weight of the composition. Examples of suitable fillers, cavitating agents, and/or nucleating agents include, but are not limited to, titanium dioxide, calcium carbonate, barium sulfate, silica, silicon dioxide, carbon black, sand, glass beads, mineral aggregates, talc, clay, and the like.

In embodiments, antioxidants and stabilizers such as organic phosphites, hindered amines, and phenolic antioxidants may be present in the polymer compositions in an amount of from about 0.001 wt. % to about 2 wt. %, from about 0.01 wt. % to about 0.8 wt. % in another embodiment, or from about 0.02 wt. % to about 0.5 wt. % based on the total weight of the composition. Non-limiting examples of organic phosphites that are suitable are tris(2,4-di-tert-butylphenyl) phosphite (IRGAFOS 168) and di(2,4-di-tert-butylphenyl) pentaerithritol diphosphite (ULTRANOX 626). Non-limiting examples of hindered amines include poly [2-N,N′-di(2,2,6,6-tetramethyl-4-piperidinyl)-hexanediamine-4-(1-amino-1,1,3,3-tetramethylbutane) sym-triazine] (CHIMASORB 944); bis(1,2,2,6,6-pentamethyl-4-piperidyl) sebacate (TINUVIN 770). Non-limiting examples of phenolic antioxidants include pentaerythrityl tetrakis(3,5-di-tert-butyl-4 -hydroxyphenyl) propionate (IRGANOX 1010); and 1,3,5-Tri (3,5-di-tert-butyl-4-hydroxybenzyl-isocyanurate (IRGANOX 3114).

In embodiments, fillers may be present from about 0.001 wt. % to about 50 wt. %, from about 0.005 wt. % to about 40 wt. %, from about 0.01 wt. % to about 25 wt. %, from about from about 0.2 wt. % to about 10 wt. % based on the total weight of the composition. Examples of suitable fillers include, but are not limited to, titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, talc and hydrotalcite-like compounds of the ions Mg, Ca, or Zn with Al, Cr or Fe and CO₃ and/or HPO₄, hydrated or not; quartz powder, hydrochloric magnesium carbonate, glass fibers, clays, alumina, and other metal oxides and carbonates, metal hydroxides, chrome, phosphorous and brominated flame retardants, antimony trioxide, silica, silicone, and blends thereof. These fillers may particularly include any other fillers and porous fillers and supports known in the art, and may have the modifier of the invention pre-contacted, or pre-absorbed into the filler prior to addition to the ethylene polymer in one embodiment.

In embodiments the polymer composition can include an acid neutralizing material. Examples of suitable acid neutralizing materials include, but are not limited to, a metal carboxylate, hydrotalcite-like compounds, hydrocalumites, zeolites, alkaline earth oxides, alkaline earth carbonates, glycerin fatty acid esters, combinations thereof, and the like. In embodiments, the acid neutralizing material is present in an amount of from about 0.001 wt. % to about 1 wt. %, from about 0.005 wt. % to about 0.9 wt. %, from about 0.01 wt. % to about 0.8 wt. %, from about 0.05 wt. % to about 0.75 wt. %, from about 0.075 wt. % to about 0.6 wt. %, or from about 0.1 wt. % to about 0.5 wt. % based on the total weight of the composition.

In one embodiment, the acid neutralizing material is selected from a metal carboxylate. In embodiments, the metal carboxylate is selected from a metal salt of a fatty acid. In embodiments, the polymer composition may comprise a metal salt of a fatty acid in an amount of from about 0.001 wt. % to about 1 wt. %, from about 0.005 wt. % to about 0.9 wt. %, from about 0.01 wt. % to about 0.8 wt. %, from about 0.05 wt. % to about 0.75 wt. %, from about 0.075 wt. % to about 0.6 wt. %, or from about 0.1 wt. % to about 0.5 wt. % based on the total weight of the composition. Examples of fatty acids include lauric acid, stearic acid, succinic acid, stearyl lactic acid, lactic acid, phthalic acid, benzoic acid, hydroxystearic acid, ricinoleic acid, naphthenic acid, oleic acid, palmitic acid, erucic acid, or any monocarboxylic aliphatic saturated or unsaturated acid having a chain length of 7 to 22 carbon atoms. Suitable metals include Li, Na, Mg, Ca, Sr, Ba, Zn, Cd, Al, Sn, Pb, and so forth. Preferably, metal salts of fatty acids are magnesium stearate, calcium stearate, aluminum stearate, sodium stearate, zinc stearate, calcium oleate, zinc oleate, magnesium oleate, calcium lactate, calcium stearoyl-2-lactate, and the like.

Hydrotalcite-like compounds include those resembling or akin to hydrotalcite, which is a magnesium-aluminum hydroxycarbonate. Hydrotalcite-like compounds may be, for example, multicomponent metal compounds having a hydrotalcite-like structure and containing divalent and trivalent metal cations and a hydroxyl group. Examples of the divalent metal cation include Mg²⁺, Fe²⁺, Zn²⁺, Ca²⁺, Ni²⁺, Co²⁺, and Cu²⁺, and, from the viewpoint of heat resistance and the like. Examples of the trivalent metal cation include A¹³⁺, Fe³⁺, and Mn³⁺. Examples of hydrotalcite-like compounds include, but are not limited to, Mg₆Al₂(OH)₁₆CO₃·4H₂O and Mg₄Al₂(OH)₁₂CO₃·3H₂O. In one embodiment, hydrotalcite-like compounds include synthetic hydrotalcites based on aluminum, magnesium, and zinc.

An example of a glycerin fatty acid ester is glycerol monostearate.

In embodiments, the acid neutralizer is selected from an alkaline earth oxide or alkaline earth carbonate. Examples of such compounds include, but are not limited to, calcium oxide, magnesium oxide, zinc oxide, calcium carbonate, magnesium carbonate, and the like.

In embodiments, the product additive is selected from an antiblock. Examples of materials suitable to function as an antiblock include, but are not limited to, natural silica such as, for example, diatomaceous earth; synthetic silica; silicates such as, but not limited to, aluminium silicate, sodium aluminum silicate, calcined kaolin, aluminum silicate, or calcium silicate; synthetic zeolites such as, but not limited to, sodium calcium aluminosilicate hydrate; polymethylsilsesquioxane; talc; calcium carbonate; mica; combinations thereof; and the like.

The polymers may be formed into plastic articles by a variety of processes. Generically, this involves a melt, either partial or complete, of the polymer by heat and compression of the softened polymer into the desired shape. Some of the more conventional processes include calendaring, casting, coating, fiber spinning, extruding, laminating, blow molding, compression molding, injection molding, jet molding, post forming, shell molding, sheet forming, slush molding and vacuum forming. The present invention finds particular utility in extrusion and molding operations, and most preferably in film extrusion and injection molding.

The equipment utilized in melt polymerization processing may be made of a variety of materials and generally comprise metal dies, screws, tubes, and the like. The equipment and various components are typically made from materials such as steel, including stainless and chrome plated; bronze; sintered bronze; brass; and nickel. In addition, various non-metallic fabrication surfaces may be employed such as glass, graphite, ceramics, and the like.

The present technology has been described in the foregoing detailed description and with reference to various aspects and embodiments. The technology may be further understood with reference to the following Examples. The Examples are intended to further illustrate aspects and embodiments of the present technology and not necessarily to be limited to such aspects or embodiments.

### EXAMPLES

Table 1 provides a list of the materials used in the examples.

TABLE 1
Description of different materials used in Examples.

| Material Name | Description |
|---|---|
| Silquest ™ | Organo-silicone polymer processing |
| PA-1 | aid (x:y ratio = 13.8, z = 0) |
| | prepared by Momentive Performance Materials. |
| PEG35K | Sigma Aldrich, Product Number: 94646, |
| | Mn: 35,000 g/mol |
| PEG3.35K | Sigma Aldrich, Product Number: 202444, |
| | Mn: 3350 g/mol |
| Zinc Stearate | Thermo Scientific, Product Number: |
| 12.5%-14% | 033238.A1, MW: 632.332 g/mol |
| L-7604 | Organo-silicone polymer processing |
| | (x:y ratio = 2.7, z = 0) |
| | prepared by Momentive |
| PLA | NatureWorks Ingeo ™ Biopolymer |
| | 4043D, Mn: 111,000 g/mol |

Silquest™ PA-1 and L-7604 of Table 1 follow the generic structure listed below where R¹, R², R³, R⁴, R⁵, R⁶, R⁷, R⁸, R⁹, R¹⁰, R¹¹, and R¹² have the same identity and differ on only in the x:y monomer ratio.

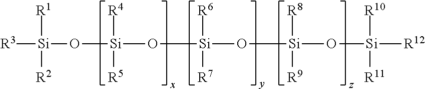

Table 2 and Table 3 describe the formulations discussed herein. For all formulations, the same m-LLDPE (MFI: 3 g/10 min; 190° C.@ 2.16) base resin was used to test their performance during blown film extrusion. The formulations listed in Table 2 were all compounded directly into the previously mentioned m-LLDPE and the tested on the blown film extrusion line. The formulations listed in Table 3 were first compounded into a 2% masterbatch using LyondellBasell GA 564189 m-LLDPE (MFI: 20 g/10 min; 190° C.@ 2.16]) as a carrier resin then tested on the blown film extrusion line using the previously mentioned base resin.

TABLE 2
Formulation preparation:

| | | | | Residual | |
|---|---|---|---|---|---|
| | | | | Melt | Pressure |
| | | | | Fracture | Drop |
| Sam- | Silicone | | Product | [% after | [% after |
| ple | Polymer | Adjuvant | Additive | 120 min] | 120 min] |
| 1 | Silquest ™ | N/A | N/A | 15 | 8.0 |
| | PA-1 1000 ppm | | | | |
| 2 | Silquest ™ | PEG3.35K | N/A | 10 | 2.2 |
| | PA-1 500 ppm | 500 ppm | | | |
| 3 | Silquest ™ | PEG35K | N/A | 0.5 | 4.7 |
| | PA-1 500 ppm | 500 ppm | | | |
| 4 | Silquest ™ | PLA | N/A | 3 | 11.3 |
| | PA-1 500 ppm | 500 ppm | | | |

All formulations were prepared using twin screw extruder where the adjuvant and/or product additive(s) were pre-blended with the base resin using a planetary mixer and added directly into the hopper for compounding.

Blown film processing: Each formulation was tested using a 45 mm single screw blown film extruder at 180° C. with a 30/1 L/D ratio, 3.14 die diameter, 0.047 die gap, and operated under constant throughput (19-21 kg/hr).

TABLE 3
Formulation preparation by compounding a 2% masterbatch:

| | | | | Pressure Drop |
|---|---|---|---|---|
| | Silicone Polymer | | Product | [% after |
| Sample | [from 2% MB] | Adjuvant | Additive | 24 min] |
| 5 | Silquest ™ PA-1 | N/A | N/A | 49% |
| | 1000 ppm | | | |
| 6 | L-7604 | N/A | N/A | 29% |
| | 1000 ppm | | | |
| 7 | Silquest ™ PA-1 | N/A | Zinc Stearate | 39% |
| | 1000 ppm | | 500 ppm | |
| 8 | Silquest ™ PA-1 | PEG 3.35K | Zinc Stearate | 48% |
| | 500 ppm | 500 ppm | 500 ppm | |

All formulations were prepared by compounding a 2% masterbatch of the processing aid using an 18 mm co-rotating twin-screw extruder (operated at 200 rpm & 195° C.). The adjuvant and/or product additives were pre-blended with the carrier resin using a planetary mixer then added directly to the extruder hopper.

Blown film processing: The masterbatches were blended with the base resin and added directly into the blown film extruder hopper. For Samples 7 & 8, the zinc stearate was blended along with masterbatches into the base resin prior to run. The above formulations were tested using a 2.5 inch blown film extruder at 200° C., with a 24/1 L/D ratio, 100 mm die diameter, a 0.75 mm die gap, and 45 rpm extruder screw speed (45 rpm).

Sample 1 (Comparative Example): Processing aid used is Silquest™ PA-1 from Momentive dispersed in the m-LLDPE base resin (Table 2, entry 1).

Sample 2: A processing aid is prepared by combining PA-1 along with a polyethylene glycol having a weight average molecular weight of 3.350 kg/mol. The components are dispersed in the m-LLDPE base resin. The silicone-based polymer and the polyethylene glycol are provided in a 1:1 weight ratio (Table 2, entry 2).

Sample 3: A processing aid is prepared by combining PA-1 along with a polyethylene glycol having a weight average molecular weight of 35 kg/mol. The components are dispersed in the m-LLDPE base resin. The silicone-based polymer and the polyethylene glycol are provided in a 1:1 weight ratio (Table 2, entry 3).

Sample 4: A processing aid is prepared by combining PA-1 along with a poly(lactic acid) (PLA) having a weight average molecular weight of 111 kg/mol. The components are dispersed in the m-LLDPE base resin. The silicone-based polymer and the poly(lactic acid) are provided in a 1:1 weight ratio (Table 2, entry 4).

Sample 5: Processing aid used is Silquest™ PA-1 from Momentive dispersed in the m-LLDPE carrier resin (Table 3, entry 1).

Sample 6: Processing aid used is L-7604 from Momentive dispersed in the m-LLDPE carrier resin (Table 3, entry 2).

Sample 7: A processing aid is prepared by combining PA-1 along with the zinc stearate (Thermo Scientific, Product Number: 033238). The components are dispersed in the m-LLDPE base resin. The silicone-based polymer and the zinc stearate are provided in a 2:1 weight ratio (Table 3, entry 3).

Sample 8: A processing aid is prepared by combining PA-1 along with polyethylene glycol (weight average molecular weight of 3.35 kg/mol) and zinc stearate. The components are dispersed in the m-LLDPE base resin. The silicone-based polymer, polyethylene glycol, and the zinc stearate are provided in a 1:1:1 weight ratio (Table 3, entry 4).

Extruder processability evaluations were carried out using the conditions provided in Table 2 and Table 3. Extruder pressure measured at the final extruder zone was recorded by the computer automatically throughout the test. Experiments were carried out by running an abrasive purge compound to remove any processing aid layer. At the start of each experiment, the feed was switched to the formulation being tested. The pressure drop readings were recorded over time and samples of the film extrudate were collected to determine the residual amount of melt fracture. The extruder pressure drop was computed by dividing the pressure at a given time (tᵢ) by the pressure at the beginning of the run (t₀). The pressure drop recorded in Table 2 and Table 3 are taken after sufficient time for the extrusion process to achieve steady-state operation. The residual melt fracture was calculated by taking the area of the film that contains melt fracture along the die direction (A_{MF}) and dividing it by the total area of the film (A_{film}).

Sample 1 employs the organo-silicone polymer processing aid (1000 ppm Silquest PA-1) yielding 15% residual melt fracture in the film extrudate after 120 minutes of extrusion. Samples 2 and 3 contain equivalent PPA dosage (1000 PPM) with a 1:1 ratio organo-silicone PPA to polyethylene glycol have a weight average molecular weight of 3.35 & 35 kg/mol respectively. Both Samples 2 and 3 exhibit enhanced melt fracture elimination performance compared to PA-1 demonstrating the enhancement between the adjuvant and the PPA. Sample 3 has the best melt fracture elimination performance with only 0.5% residual melt fracture suggesting the adjuvant enhancement improves with increasing adjuvant weight average molecular weight. Sample 4 contains an alternative adjuvant chemistry (polylactic acid) of high weight average molecular weight and display results akin to Sample 3. The comparison between Sample 4 and Sample 3 with Sample 1 suggests that aforementioned enhancement is not specific to singular adjuvant chemistry.

The organo-silicone efficacy as a polymer processing aid is impacted by its macromolecular structure as demonstrated by comparing Sample 5 to Sample 6. Both Samples 5 & 6 have the same monomer side chain identity (R4, R5, R6, R7, R8, and R9) but differ dramatically in monomer ratios (x:y monomer ratio). Sample 5 had a 48% steady-state pressure drop compared to Sample 6 with 29%. Both formulations experienced the same processing history and only differ in PPA macromolecular structure suggesting the side chain identities (R4, R5, R6, R7, R8, and R9) and the copolymer monomer ratios (x:y:z) have a direct impact on PPA efficacy.

When the polymer composition includes 500 ppm of Zinc Stearate (Sample 7), the pressure drop compared to Sample 5 decreased by 10%. Meaning, the observed lubrication efficiency of PA-1 is decreased by ~10%. However, in Sample 8, replacing 500 ppm of Silquest PA-1 with 500 ppm of PEG 3.35 k yields an observed pressure drop of 48% in the presence of 500 ppm zinc stearate. This pressure drop is closer to that observed with Sample 5 and is 10% higher than the pressure drop in Sample 7. Thus, the processing aid comprising silicone polymer and the adjuvant can provide improved performance even in the presence of other product additives such as, for example, zinc stearate.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a polymer processing aid and the use of such polymer processing aids in polymer compositions used to form polymeric materials by melt processing methods. Modifications may occur to those skilled in the art and to those who may make and use the invention. The disclosed embodiments are merely for illustrative purposes and not intended to limit the scope of the invention or the subject matter set forth in the claims.

What is claimed is:

1. A polymer processing aid comprising:
(i) a silicone polymer of the formula: 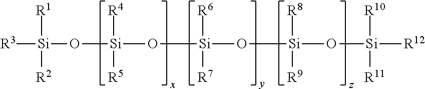
where R¹, R², R⁴, R⁵, R⁶, R⁸, R¹⁰, and R¹¹ are independently selected from a C1-C12 alkyl;
R⁷ is selected from an organic group selected from an alkylene oxide group, a hydroxy group, an alcohol, a carboxy group, an alkoxy group, an epoxy group, or an amino group;
R³, R⁹, and R¹² are independently selected from a C1-C12 alkyl and R⁷;
x is 1 to 500;
y is 1 to 300; and
z is 0 to 500;
(ii) an adjuvant selected from an aliphatic polyester; an aromatic polyester; a polyether; a polyglycerol, and/or a polyglycerol fatty acid ester; a polyacrylic acid or a derivative thereof; an ethylene-maleic anhydride copolymer; a polyvinyl alcohol or a derivative thereof; a cellulose derivative; a polymer of polystyrene, poly(meth)acrylate, polyamides, polycarbonates, polysulfones; or a combinations thereof; polylactic acid; and
(iii) a product additive selected from a pigment, a dye, a heat stabilizer, a UV stabilizer, an antiblock agent, an acid neutralizer, or a combination of two or more thereof.

2. The polymer processing aid of claim 1, wherein the product additive is selected from an acid neutralizer, where the acid neutralizer is selected from an alkaline earth oxide, alkaline earth carbonate, a hydrotalcite-like compound, a metal carboxylate or a combination of two or more thereof.

3. The polymer processing aid of claim 2, wherein the acid neutralizer is selected from zinc oxide, zinc stearate, calcium stearate, or a combination of two or more thereof.

4. The polymer processing aid of claim 1, wherein the adjuvant is selected from a polyether, an aliphatic polyester, an aromatic polyester, or a combination of two or more thereof.

5. The polymer processing aid of claim 1, wherein the adjuvant comprises a polyether selected from a polyether glycol.

6. The polymer processing aid of claim 1, wherein the adjuvant comprises polyethylene glycol, polycaprolactone, or a combination of two or more thereof.

7. The polymer processing aid of claim 5, wherein the adjuvant has a weight average molecular weight of from about 200 to about 200,000 g/mol.

8. The polymer processing aid of claim 5, wherein the adjuvant has a weight average molecular weight of from greater than 20,000 to about 200,000 g/mol.

9. The polymer processing aid of claim 1, having a ratio of silicone polymer (i) to adjuvant (ii) of from about 4:1 to about 1:4 on a weight basis.

10. The polymer processing aid of claim 1, having a ratio of silicone polymer (i) to adjuvant (ii) of 1:1 on a weight basis.

11. The polymer processing aid of claim 1, wherein the silicone polymer (i) has a weight average molecular weight of from about 500 to about 1,000,000 g/mol.

12. The polymer processing aid of claim 1, wherein the product additive is selected from a metal carboxylate, hydrotalcite-like compounds, hydrocalumites, zeolites, alkaline earth oxides, alkaline earth carbonates, glycerin fatty acid esters.

13. The polymer processing aid of claim 1, wherein the product additive is selected from an antiblock material selected from natural silica; synthetic silica; a silicate; a synthetic zeolite; a polymethylsilsesquioxane; talc; calcium carbonate; mica; or a combination thereof.

14. The polymer processing aid of claim 1 in the form of a masterbatch, wherein the silicone polymer (i), the adjuvant (ii), and the product additive (iii) are disposed in a carrier resin.

15. The polymer processing aid of claim 14, wherein the carrier resin is selected from a thermoplastic polymer.

16. The polymer processing aid of claim 15, wherein the thermoplastic polymer is selected from a polyolefin.

17. An extrudable composition comprising (i) a thermoplastic polymer, and (ii) the polymer processing aid of claim 1.

18. The extrudable composition of claim 16, wherein the polymer processing aid is present in an amount of from about 100 ppm to about 10,000 ppm based on the total weight of the composition.

19. The extrudable composition of claim 17, wherein the thermoplastic polymer is selected from a polyolefin, a polyamide, a polyester, a styrenic polymer, an acrylic, a methacrylic, polyoxyalkylene, a diene elastomer, a polyacetal, a polycarbonate, a polysulfone, a polyurethane, or a combination of two or more thereof.

20. The extrudable composition of claim 17, wherein the thermoplastic polymer is selected from a polyolefin.

21. The extrudable composition of claim 20, wherein the polyolefin is selected from a polyethylene polymer.

22. The extrudable composition of claim 17 further comprising a product additive selected from an antioxidants, a nucleating agent, an acid scavenger, a stabilizer, an anticorrosion agent, a plasticizer, a blowing agent, a cavitating agent, a surfactant, a block, an antiblock, a UV absorber, a quenchers, an antistatic agent, a slip agent, a processing aid, a UV stabilizer, a neutralizer, a lubricant, a wax, a pigment, a dye, a filler, a cure agent, or combination of two or more thereof.

23. The extrudable composition of claim 22, wherein the product additive is present in an amount of from about 0.001 wt. % to about 30 wt. % based on the weight of the composition.

24. The extrudable composition of claim 17 wherein the product additive is selected from a metal carboxylate.

25. The extrudable composition of claim 24, wherein the metal carboxylate is selected from zinc stearate.

26. The extrudable composition of claim 24, wherein the product additive is present in an amount of from about 0.001 wt. % to about 1 wt. % based on the weight of the composition.

27. The extrudable composition of claim 23, wherein the adjuvant has a weight average molecular weight of from greater than 20,000 to about 200,000 g/mol.

28. A process of forming a polymeric material comprising extruding the composition of claim 17 through an extruder die.

29. An extruded thermoplastic product produced from the extrudable composition of claim 17.

30. A polymer processing aid comprising:
(i) a silicone polymer of the formula: 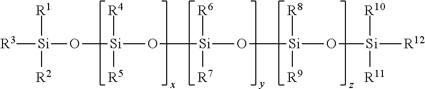
where R¹, R², R⁴, R⁵, R⁶, R⁸, R¹⁰, and R¹¹ are independently selected from a C1-C12 alkyl;
R⁷ is selected from an organic group selected from an alkylene oxide group, a hydroxy group, an alcohol, a carboxy group, an alkoxy group, an epoxy group, or an amino group;
R³, R⁹, and R¹² are independently selected from a C1-C12 alkyl and R⁷;
x is 1 to 500;
y is 1 to 300; and
z is 0 to 500;
(ii) an adjuvant selected from an aliphatic polyester; an aromatic polyester; a polyether; or a combinations thereof, wherein the adjuvant has a weight average molecular weight of greater than 20,000 g/mol.

31. The polymer processing aid of claim 30, wherein the adjuvant has a weight average molecular weight of from greater than 20,000 to about 200,000 g/mol.

32. The polymer processing aid of claim 30 having a ratio of silicone polymer (i) to adjuvant (ii) of from about 9:1 to about 1:9 on a weight basis.

33. An extrudable composition comprising (i) a thermoplastic polymer, and (ii) the polymer processing aid of claim 30.
